(19) United States
(12) Patent Application Publication
(10) Pub. No.: US 2017/0108293 A1
(43) Pub. Date: Apr. 20, 2017

(54) Crimp Joint with O-Rings Enhanced with Adhesive and Incorporated to Manifold Feeder Tubes

(71) Applicant: Trane International Inc., Davidson, NC (US)

(72) Inventors: Raymond S. Schafer, Holmen, WI (US); Kari Terho, Bullard, TX (US)

(21) Appl. No.: 15/240,802

(22) Filed: Aug. 18, 2016

Related U.S. Application Data
(60) Provisional application No. 62/243,989, filed on Oct. 20, 2015.

(51) Int. Cl. F28F 9/02; B23P 15/26

(52) U.S. Cl. CPC F28F 9/0256; B23P 15/26

(57) ABSTRACT

Systems and methods are disclosed that include providing a heating, ventilation, and/or air conditioning (HVAC) system with a spine fin heat exchanger comprising elliptical heat exchanger tubes joined to elliptical feeder tubes extending from the heat exchanger manifold by a crimp joint that is configured such that the heat exchanger tubes are inserted into corresponding feeder tubes. The crimp joint includes at least two O-rings disposed between an outer diameter of each of the heat exchanger tubes and an inner diameter of each of the feeder tubes. The O-rings form a fluid tight seal between the heat exchanger tubes and the feeder tubes. Adhesive is also disposed between the O-rings, and the feeder tube is crimped about the heat exchanger tube and the O-rings to form a reliable fluid tight seal between each heat exchanger tube and corresponding feeder tube.

### CROSS-REFERENCE TO RELATED APPLICATIONS

The present application claims priority under 35 U.S.C. 119(e) to U.S. Provisional Patent Application No. 62/243,989 filed on Oct. 20, 2015 by Schafer, et al., and entitled “Crimp Joint with O-Rings Enhanced with Adhesive and Incorporated to Manifold Feeder Tubes,” the disclosure of which is hereby incorporated by reference in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Heating, ventilation, and/or air conditioning (HVAC) systems may generally be used in residential and/or commercial areas for heating and/or cooling to create comfortable temperatures inside those areas. Most HVAC systems typically employ one or more heat exchangers for accomplishing the exchange of heat between a refrigerant flowing through the heat exchanger and an airflow that contacts the heat exchanger in order to cool and/or heat a comfort zone of a dwelling and/or building. Because capacity and/or efficiency of an HVAC system may rely on having a correct refrigerant charge, operating temperature, and/or operating pressure within the system, it is critical to provide connections and/or joints in the refrigeration fluid circuit that are free of leaks.

### SUMMARY

In some embodiments of the disclosure, a heat exchanger is disclosed as comprising: a manifold; at least one feeder tube extending from the manifold; at least one heat exchanger tube; and a joint that provides a fluid tight seal between the feeder tube and the heat exchanger tube, wherein at least two O-rings are disposed between the feeder tube and the heat exchanger tube, and wherein an adhesive is applied at least in a space between the two O-rings, the feeder tube, and the heat exchanger tube.

In other embodiments of the disclosure, a heating, ventilation, and/or air conditioning (HVAC) system is disclosed as comprising: a heat exchanger comprising a manifold; at least one feeder tube extending from the manifold; at least one heat exchanger tube; and a joint that provides a fluid tight seal between the feeder tube and the heat exchanger tube, wherein at least two O-rings are disposed between the feeder tube and the heat exchanger tube, and wherein an adhesive is applied at least in a space between the two O-rings, the feeder tube, and the heat exchanger tube.

In other embodiments of the disclosure, a method of assembling a joint is disclosed as comprising: providing at least one heat exchanger comprising a manifold, at least one feeder tube extending from the manifold, and at least one heat exchanger tube; disposing O-rings around the heat exchanger tube of the heat exchanger; inserting the heat exchanger tube into a portion of the feeder tube; applying adhesive between the heat exchanger tube and the feeder tube; and crimping the feeder tube over the heat exchanger tube and the O-rings.

### BRIEF DESCRIPTION OF THE DRAWINGS

For a more complete understanding of the present disclosure and the advantages thereof, reference is now made to the following brief description, taken in connection with the accompanying drawings and detailed description:

FIG. 1 is a schematic diagram of an HVAC system according to an embodiment of the disclosure;

FIG. 2 is a schematic diagram of a crimp joint of the outdoor heat exchanger of FIG. 1 according to an embodiment of the disclosure; and

FIG. 3 is a flowchart of a method of assembling a joint according to an embodiment of the disclosure.

### DETAILED DESCRIPTION

In some cases, it may be desirable to provide a crimp joint having a plurality of O-rings and enhanced with adhesive between a manifold of a heat exchanger and the heat exchanger feeder tubes. For instance, the performance of traditional style heat exchangers is often diminished due to an incorrect and/or insufficient refrigerant charge. By providing a crimp joint having a plurality of O-rings and enhanced with adhesive between the manifold of the heat exchanger and the heat exchanger feeder tubes, the crimp joint may provide a hermetic seal that is resistant to refrigerant leakage, and/or damage due to extreme and/or changing temperatures. Additionally, with the introduction of spine fin heat exchangers that often employ elliptical feeder tubes, current methods of joining the feeder tubes to the manifold may not be reliable and/or effective. Furthermore, the elliptical feeder tubes often have a ridge on the inner surface and/or glue on the outer surface that poses problems to current methods of joining feeder tubes to the manifold. Thus, a crimp joint having a plurality of O-rings and enhanced with adhesive may ensure a longer lifespan and/or provide an enhanced hermetic seal that is more resistant to refrigerant leakage than current methods.

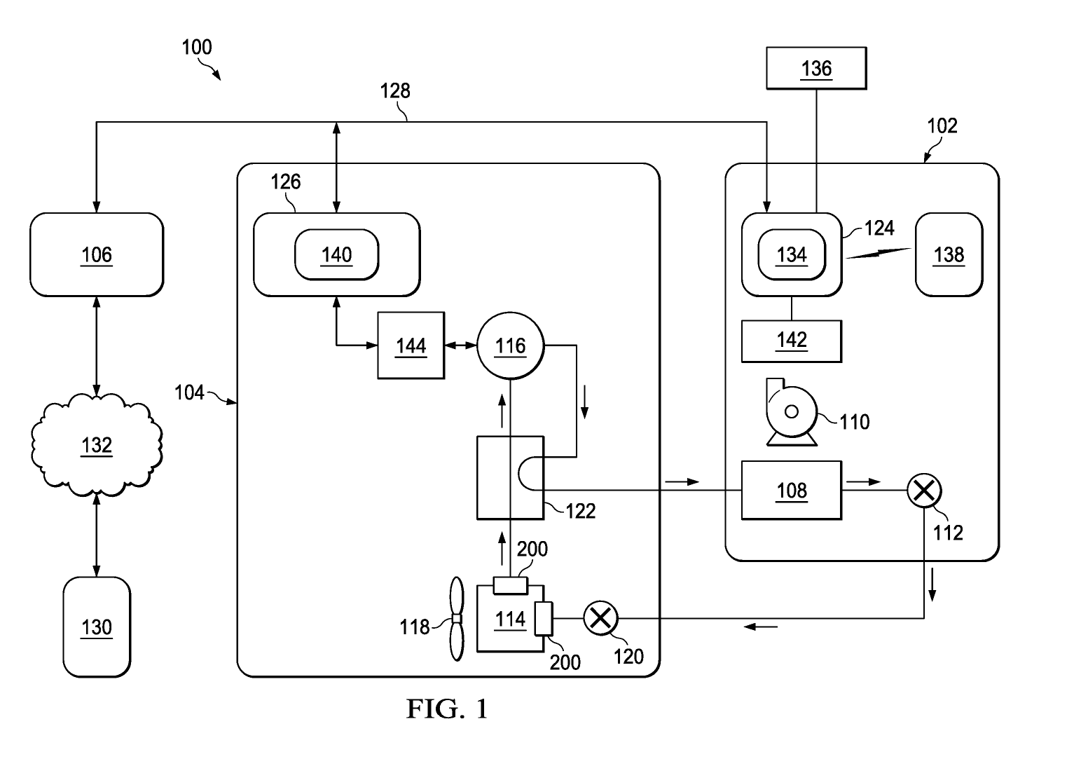

Referring now to FIG. 1, a schematic diagram of an HVAC system 100 is shown according to an embodiment of the disclosure. Most generally, HVAC system 100 comprises a heat pump system that may be selectively operated to implement one or more substantially closed thermodynamic refrigeration cycles to provide a cooling functionality (hereinafter, “cooling mode”) and/or a heating functionality (hereinafter, “heating mode”). The HVAC system 100, configured as a heat pump system, generally comprises an indoor unit 102, an outdoor unit 104, and a system controller 106 that may generally control operation of the indoor unit 102 and/or the outdoor unit 104.

Indoor unit 102 generally comprises an indoor air handling unit comprising an indoor heat exchanger 108, an indoor fan 110, an indoor metering device 112, and an indoor controller 124. The indoor heat exchanger 108 may generally be configured to promote heat exchange between refrigerant carried within internal tubing of the indoor heat exchanger 108 and an airflow that may contact the indoor heat exchanger 108 but that is segregated from the refrigerant. In some embodiments, the indoor heat exchanger 108 may comprise a plate fin heat exchanger. However, in other embodiments, indoor heat exchanger 108 may comprise a microchannel heat exchanger, a spine fin heat exchanger, and/or any other suitable type of heat exchanger.

The indoor fan 110 may generally comprise a centrifugal blower comprising a blower housing, a blower impeller at least partially disposed within the blower housing, and a blower motor configured to selectively rotate the blower impeller. The indoor fan 110 may generally be configured to provide airflow through the indoor unit 102 and/or the indoor heat exchanger 108 to promote heat transfer between the airflow and a refrigerant flowing through the indoor heat exchanger 108. The indoor fan 110 may also be configured to deliver temperature-conditioned air from the indoor unit 102 to one or more areas and/or zones of a climate controlled structure. The indoor fan 110 may generally comprise a mixed-flow fan and/or any other suitable type of fan. The indoor fan 110 may generally be configured as a modulating and/or variable speed fan capable of being operated at many speeds over one or more ranges of speeds. In other embodiments, the indoor fan 110 may be configured as a multiple speed fan capable of being operated at a plurality of operating speeds by selectively electrically powering different ones of multiple electromagnetic windings of a motor of the indoor fan 110. In yet other embodiments, however, the indoor fan 110 may be a single speed fan.

The indoor metering device 112 may generally comprise an electronically-controlled motor-driven electronic expansion valve (EEV). In some embodiments, however, the indoor metering device 112 may comprise a thermostatic expansion valve, a capillary tube assembly, and/or any other suitable metering device. In some embodiments, while the indoor metering device 112 may be configured to meter the volume and/or flow rate of refrigerant through the indoor metering device 112, the indoor metering device 112 may also comprise and/or be associated with a refrigerant check valve and/or refrigerant bypass configuration when the direction of refrigerant flow through the indoor metering device 112 is such that the indoor metering device 112 is not intended to meter or otherwise substantially restrict flow of the refrigerant through the indoor metering device 112.

Outdoor unit 104 generally comprises an outdoor heat exchanger 114, a compressor 116, an outdoor fan 118, an outdoor metering device 120, a reversing valve 122, and an outdoor controller 126. In some embodiments, the outdoor unit 104 may also comprise a plurality of temperature sensors for measuring the temperature of the outdoor heat exchanger 114, the compressor 116, and/or the outdoor ambient temperature. The outdoor heat exchanger 114 may generally be configured to promote heat transfer between a refrigerant carried within internal passages of the outdoor heat exchanger 114 and an airflow that contacts the outdoor heat exchanger 114 but that is segregated from the refrigerant. In this embodiment, outdoor heat exchanger 114 comprises a spine fin heat exchanger. The outdoor heat exchanger 114 generally comprises at least one crimp joint 200 that joins a feeder tube extending from a manifold of the outdoor heat exchanger 114 to at least one heat exchanger tube of the outdoor heat exchanger 114. However, in some embodiments, the outdoor heat exchanger 114 comprises a plurality of crimp joints 200 that each join a feeder tube extending from the manifold of the outdoor heat exchanger 114 to a heat exchanger tube of the outdoor heat exchanger 114. In some embodiments, the outdoor heat exchanger 114 may comprise a spine fin heat exchanger having a plurality of elliptical heat exchanger tubes joined to a plurality of feeder tubes extending from the manifold via a plurality of crimp joints 200. However, in other embodiments, outdoor heat exchanger 114 may comprise a plate fin heat exchanger, a microchannel heat exchanger, or any other suitable type of heat exchanger.

The compressor 116 may generally comprise a variable speed scroll-type compressor that may generally be configured to selectively pump refrigerant at a plurality of mass flow rates through the indoor unit 102, the outdoor unit 104, and/or between the indoor unit 102 and the outdoor unit 104. In some embodiments, the compressor 116 may comprise a rotary type compressor configured to selectively pump refrigerant at a plurality of mass flow rates. In alternative embodiments, however, the compressor 116 may comprise a modulating compressor that is capable of operation over a plurality of speed ranges, a reciprocating-type compressor, a single speed compressor, and/or any other suitable refrigerant compressor and/or refrigerant pump. In some embodiments, the compressor 116 may be controlled by a compressor drive controller 144, also referred to as a compressor drive and/or a compressor drive system.

The outdoor fan 118 may generally comprise an axial fan comprising a fan blade assembly and fan motor configured to selectively rotate the fan blade assembly. The outdoor fan 118 may generally be configured to provide airflow through the outdoor unit 104 and/or the outdoor heat exchanger 114 to promote heat transfer between the airflow and a refrigerant flowing through the indoor heat exchanger 108. The outdoor fan 118 may generally be configured as a modulating and/or variable speed fan capable of being operated at a plurality of speeds over a plurality of speed ranges. In other embodiments, the outdoor fan 118 may comprise a mixed-flow fan, a centrifugal blower, and/or any other suitable type of fan and/or blower, such as a multiple speed fan capable of being operated at a plurality of operating speeds by selectively electrically powering different multiple electromagnetic windings of a motor of the outdoor fan 118. In yet other embodiments, the outdoor fan 118 may be a single speed fan. Further, in other embodiments, however, the outdoor fan 118 may comprise a mixed-flow fan, a centrifugal blower, and/or any other suitable type of fan and/or blower.

The outdoor metering device 120 may generally comprise a thermostatic expansion valve. In some embodiments, however, the outdoor metering device 120 may comprise an electronically-controlled motor driven EEV similar to indoor metering device 112, a capillary tube assembly, and/or any other suitable metering device. In some embodiments, while the outdoor metering device 120 may be configured to meter the volume and/or flow rate of refrigerant through the outdoor metering device 120, the outdoor metering device 120 may also comprise and/or be associated with a refrigerant check valve and/or refrigerant bypass configuration when the direction of refrigerant flow through the outdoor metering device 120 is such that the outdoor metering device 120 is not intended to meter or otherwise substantially restrict flow of the refrigerant through the outdoor metering device 120.

The reversing valve 122 may generally comprise a four-way reversing valve. The reversing valve 122 may also comprise an electrical solenoid, relay, and/or other device configured to selectively move a component of the reversing valve 122 between operational positions to alter the flowpath of refrigerant through the reversing valve 122 and consequently the HVAC system 100. Additionally, the reversing valve 122 may also be selectively controlled by the system controller 106 and/or an outdoor controller 126.

The system controller 106 may generally be configured to selectively communicate with an indoor controller 124 of the indoor unit 102, an outdoor controller 126 of the outdoor unit 104 and/or other components of the HVAC system 100. In some embodiments, the system controller 106 may be configured to control operation of the indoor unit 102 and/or the outdoor unit 104. In some embodiments, the system controller 106 may be configured to monitor and/or communicate with a plurality of temperature sensors associated with components of the indoor unit 102, the outdoor unit 104, and/or the ambient outdoor temperature. Additionally, in some embodiments, the system controller 106 may comprise a temperature sensor and/or may further be configured to control heating and/or cooling of zones associated with the HVAC system 100. In other embodiments, however, the system controller 106 may be configured as a thermostat for controlling the supply of conditioned air to zones associated with the HVAC system 100.

The system controller 106 may also generally comprise a touchscreen interface for displaying information and for receiving user inputs. The system controller 106 may display information related to the operation of the HVAC system 100 and may receive user inputs related to operation of the HVAC system 100. However, the system controller 106 may further be operable to display information and receive user inputs tangentially and/or unrelated to operation of the HVAC system 100. In some embodiments, however, the system controller 106 may not comprise a display and may derive all information from inputs from remote sensors and remote configuration tools.

In some embodiments, the system controller 106 may be configured for selective bidirectional communication over a communication bus 128. In some embodiments, portions of the communication bus 128 may comprise a three-wire connection suitable for communicating messages between the system controller 106 and one or more of the HVAC system 100 components configured for interfacing with the communication bus 128. Still further, the system controller 106 may be configured to selectively communicate with HVAC system 100 components and/or any other device 130 via a communication network 132. In some embodiments, the communication network 132 may comprise a telephone network, and the other device 130 may comprise a telephone. In some embodiments, the communication network 132 may comprise the Internet, and the other device 130 may comprise a smartphone and/or other Internet-enabled mobile telecommunication device. In other embodiments, the communication network 132 may also comprise a remote server.

The indoor controller 124 may be carried by the indoor unit 102 and may generally be configured to receive information inputs, transmit information outputs, and/or otherwise communicate with the system controller 106, the outdoor controller 126, and/or any other device 130 via the communication bus 128 and/or any other suitable medium of communication. In some embodiments, the indoor controller 124 may be configured to communicate with an indoor personality module 134 that may comprise information related to the identification and/or operation of the indoor unit 102. In some embodiments, the indoor controller 124 may be configured to receive information related to a speed of the indoor fan 110, transmit a control output to an electric heat relay, transmit information regarding an indoor fan 110 volumetric flow-rate, communicate with and/or otherwise affect control over an air cleaner 136, and communicate with an indoor EEV controller 138. In some embodiments, the indoor controller 124 may be configured to communicate with an indoor fan controller 142 and/or otherwise affect control over operation of the indoor fan 110. In some embodiments, the indoor personality module 134 may comprise information related to the identification and/or operation of the indoor unit 102 and/or a position of the outdoor metering device 120.

The indoor EEV controller 138 may be configured to receive information regarding temperatures and/or pressures of the refrigerant in the indoor unit 102. More specifically, the indoor EEV controller 138 may be configured to receive information regarding temperatures and pressures of refrigerant entering, exiting, and/or within the indoor heat exchanger 108. Further, the indoor EEV controller 138 may be configured to communicate with the indoor metering device 112 and/or otherwise affect control over the indoor metering device 112. The indoor EEV controller 138 may also be configured to communicate with the outdoor metering device 120 and/or otherwise affect control over the outdoor metering device 120.

The outdoor controller 126 may be carried by the outdoor unit 104 and may be configured to receive information inputs, transmit information outputs, and/or otherwise communicate with the system controller 106, the indoor controller 124, and/or any other device via the communication bus 128 and/or any other suitable medium of communication. In some embodiments, the outdoor controller 126 may be configured to communicate with an outdoor personality module 140 that may comprise information related to the identification and/or operation of the outdoor unit 104. In some embodiments, the outdoor controller 126 may be configured to receive information related to an ambient temperature associated with the outdoor unit 104, information related to a temperature of the outdoor heat exchanger 114, and/or information related to refrigerant temperatures and/or pressures of refrigerant entering, exiting, and/or within the outdoor heat exchanger 114 and/or the compressor 116. In some embodiments, the outdoor controller 126 may be configured to transmit information related to monitoring, communicating with, and/or otherwise affecting control over the compressor 116, the outdoor fan 118, a solenoid of the reversing valve 122, a relay associated with adjusting and/or monitoring a refrigerant charge of the HVAC system 100, a position of the indoor metering device 112, and/or a position of the outdoor metering device 120. The outdoor controller 126 may further be configured to communicate with and/or control a compressor drive controller 144 that is configured to electrically power and/or control the compressor 116.

The HVAC system 100 is shown configured for operating in a so-called heating mode in which heat may generally be absorbed by refrigerant at the outdoor heat exchanger 114 and rejected from the refrigerant at the indoor heat exchanger 108. Starting at the compressor 116, the compressor 116 may be operated to compress refrigerant and pump the relatively high temperature and high pressure compressed refrigerant through the reversing valve 122 and to the indoor heat exchanger 108, where the refrigerant may transfer heat to an airflow that is passed through and/or into contact with the indoor heat exchanger 108 by the indoor fan 110. After exiting the indoor heat exchanger 108, the refrigerant may flow through and/or bypass the indoor metering device 112, such that refrigerant flow is not substantially restricted by the indoor metering device 112. Refrigerant generally exits the indoor metering device 112 and flows to the outdoor metering device 120, which may meter the flow of refrigerant through the outdoor metering device 120, such that the refrigerant downstream of the outdoor metering device 120 is at a lower pressure than the refrigerant upstream of the outdoor metering device 120. From the outdoor metering device 120, the refrigerant may enter the outdoor heat exchanger 114. As the refrigerant is passed through the outdoor heat exchanger 114, heat may be transferred to the refrigerant from an airflow that is passed through and/or into contact with the outdoor heat exchanger 114 by the outdoor fan 118. Refrigerant leaving the outdoor heat exchanger 114 may flow to the reversing valve 122, where the reversing valve 122 may be selectively configured to divert the refrigerant back to the compressor 116, where the refrigeration cycle may begin again.

Alternatively, to operate the HVAC system 100 in a so-called cooling mode, most generally, the roles of the indoor heat exchanger 108 and the outdoor heat exchanger 114 are reversed as compared to their operation in the above-described heating mode. For example, the reversing valve 122 may be controlled to alter the flow path of the refrigerant from the compressor 116 to outdoor heat exchanger 114 first and then to the indoor heat exchanger 108, the indoor metering device 112 may be enabled, and the outdoor metering device 120 may be disabled and/or bypassed. In cooling mode, heat may generally be absorbed by refrigerant at the indoor heat exchanger 108 and rejected by the refrigerant at the outdoor heat exchanger 114. As the refrigerant is passed through the indoor heat exchanger 108, the indoor fan 110 may be operated to move air into contact with the indoor heat exchanger 108, thereby transferring heat to the refrigerant from the air surrounding the indoor heat exchanger 108. Additionally, as refrigerant is passed through the outdoor heat exchanger 114, the outdoor fan 118 may be operated to move air into contact with the outdoor heat exchanger 114, thereby transferring heat from the refrigerant to the air surrounding the outdoor heat exchanger 114.

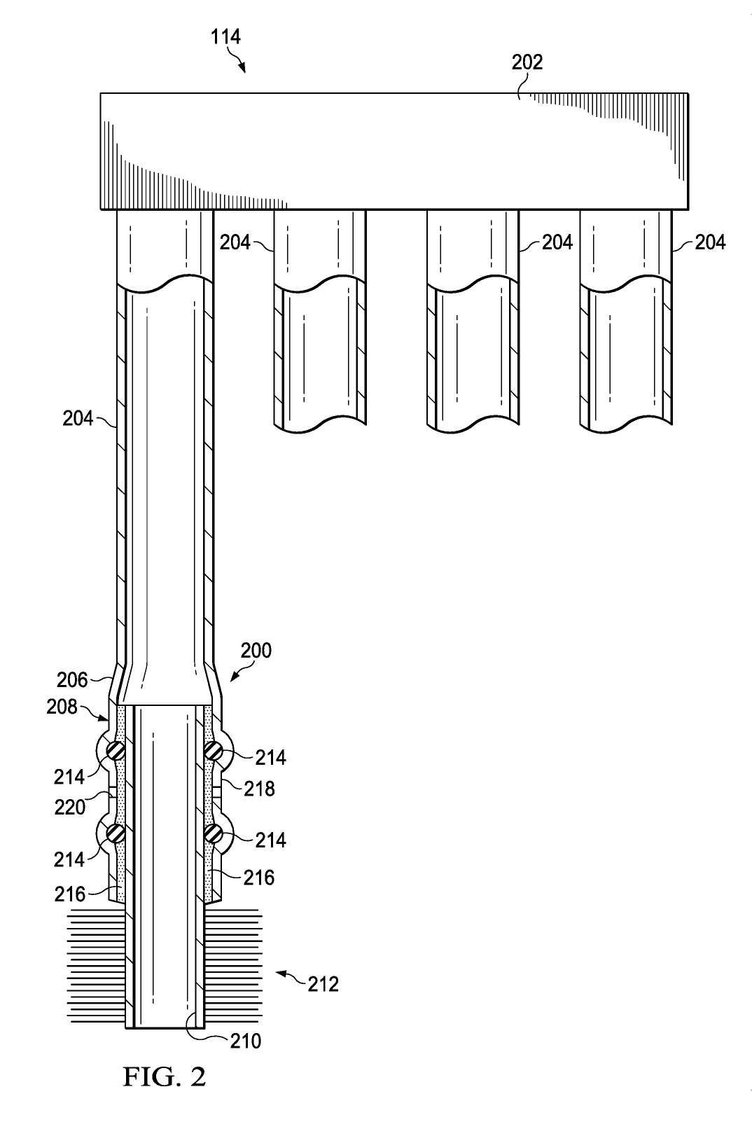

Referring now to FIG. 2, a schematic diagram of crimp joint 200 of the outdoor heat exchanger 114 is shown according to an embodiment of the disclosure. Outdoor heat exchanger 114 generally comprises a manifold 202 that is configured to feed and/or distribute refrigerant through at least one feeder tube 204 that extends from and is in fluid communication with an internal volume of the manifold 202. Outdoor heat exchanger 114 also comprises at least one heat exchanger tube 210, and at least one crimp joint 200 that joins the feeder tube 204 to the heat exchanger tube 210 to provide a fluid tight seal and/or barrier between the feeder tube 204 and the heat exchanger tube 210. However, in some embodiments, outdoor heat exchanger 114 comprises a plurality of feeder tubes 204 extending from and in fluid communication with an internal volume of the manifold 202, a plurality of heat exchanger tubes 210, and a plurality of crimp joints 200 that each joins a feeder tube 204 to a corresponding heat exchanger tube 210. In some embodiments, the outdoor heat exchanger 114 may comprise a spine fin heat exchanger having a plurality of elliptical feeder tubes 204, a plurality of elliptical heat exchanger tubes 210, and a plurality of crimp joints 200 that each joins an elliptical feeder tube 204 to a corresponding elliptical heat exchanger tube 210.

Feeder tube 204 generally comprises a straight, constant diameter tube that is generally configured to fit over the heat exchanger tube 210 at an end of the feeder tube 204 opposite from where the feeder tube 204 joins the manifold 202. To accommodate the heat exchanger tube 210, feeder tube 204 comprises an expansion 206 and a feeder tube sleeve 208. However, in other embodiments, the feeder tube 204 may not comprise the expansion 206 and the feeder tube sleeve 208, and may have an inner diameter configured to receive the heat exchanger tube 210 in a manner substantially similar to the embodiments disclosed herein having the feeder tube sleeve 208. The expansion 206 represents a section of the feeder tube 204 where the diameter and/or the cross sectional area of the feeder tube 204 gradually expands. The expansion 206 extends up to a beginning of the feeder tube sleeve 208. Accordingly, the diameter and/or cross sectional area of the feeder tube sleeve 208 comprises the largest diameter and/or cross sectional area of the expansion 206. The feeder tube sleeve 208 comprises a straight, constant diameter tube that is configured to receive the heat exchanger tube 210.

Because the feeder tube 204 expands in diameter and/or cross sectional area at the expansion, the feeder tube sleeve 208 comprises a larger diameter than the generally straight, constant diameter section of the feeder tube 204 disposed on the opposing side of the expansion 206. In some embodiments, the inner diameter of the feeder tube sleeve 208 may be larger than the outer diameter of the heat exchanger tube 210, so the feeder tube sleeve 208 may receive the heat exchanger tube 210 with minimal resistance. In some embodiments, however, the feeder tube sleeve 208 may be designed such that the difference between the inner diameter of the feeder tube sleeve 208 and the outer diameter of the heat exchanger tube 210 is about the thickness of an O-ring 214. In yet other embodiments, the difference between the inner diameter of the feeder tube sleeve 208 and the outer diameter of the heat exchanger tube 210 may be smaller than the thickness of an O-ring 214, so that the O-rings 214 provide a fluid tight seal between the feeder tube sleeve 208 and the heat exchanger tube 210.

The heat exchanger tube 210 generally comprises a substantially similar shape as the feeder tube 204 and/or the feeder tube sleeve 208. In this embodiment, where the outdoor heat exchanger 114 comprises a spine fin heat exchanger, the heat exchanger tube 210 and the feeder tube 204 comprise an elliptical cross-sectional shape. However, in other embodiments, the heat exchanger tube 210 and/or the feeder tube 204 may comprise any other shape (i.e. round, square, rectangular, and/or any other shape). Heat exchanger tube 210 comprises a plurality of fins 212 disposed along a longitudinal length of the heat exchanger tube 210. In this embodiment, where the outdoor heat exchanger 114 comprises a spine fin heat exchanger, the fins 212 are spine fins. However, in other embodiments, the outdoor heat exchanger 114 may be a plate fin heat exchanger and/or a microchannel heat exchanger. Thus, the fins 212 may be plate fins and comprise a plurality of thin, plate-like fins disposed along the longitudinal length of the heat exchanger tube 210. Additionally, while only a single heat exchanger tube 210 is depicted, it will be appreciated that the fins 212 may be disposed along a plurality of heat exchanger tubes 210.

The crimp joint 200 also comprises at least two O-rings 214 disposed between the feeder tube sleeve 208 and the heat exchanger tube 210. However, in some embodiments, more O-rings 214 may be used. The O-rings 214 are generally configured to provide a fluid tight seal between the feeder tube sleeve 208 and the heat exchanger tube 210. In other embodiments comprising a feeder tube without the expansion 206 and the feeder tube sleeve 208, the O-rings 214 may be configured to provide a fluid tight seal between the feeder tube 204 and the heat exchanger tube 210. In some embodiments, the O-rings 214 may comprise an inner diameter that is substantially equal to the outer diameter of the heat exchanger tube 210. However, in other embodiments, the O-rings 214 may comprise a diameter that is smaller than the outer diameter of the heat exchanger tube 210, so that the O-rings 214 are held in place by friction when the heat exchanger tube 210 is inserted into the feeder tube 204 and/or the feeder tube sleeve 208. Additionally, the O-rings 214 may comprise an outer diameter that is slightly larger than the inner diameter of the feeder tube sleeve 208, so that the O-rings 214 provide a fluid tight seal between the feeder tube sleeve 208 and the heat exchanger tube 210 when assembled.

After the heat exchanger tube 210 is inserted into the feeder tube sleeve 208 and the O-rings 214 are properly located between the feeder tube sleeve 208 and the heat exchanger tube 210, adhesive 216 may be applied between the feeder tube sleeve 208 and the heat exchanger tube 210. The adhesive 216 generally comprises a fast-drying, two-part epoxy resin. However, the adhesive 216 may comprise any other adhesive (i.e. single-part epoxy resin) and/or bonding component. Still further, in alternative embodiments, no adhesive 216 may be used. It will be appreciated that the adhesive 216 may come in contact with refrigerant and/or compressor oil dissolved in the refrigerant. Accordingly, adhesive 216 is resistant to damage, deterioration, and/or penetration by the refrigerant within the outdoor heat exchanger 114 and/or oil from the compressor that may reach the crimp joint 200. Most generally, the adhesive 216 is applied between the O-rings 214. However, in some embodiments, adhesive 216 may be applied outside of the O-rings 214 and/or some adhesive 216 may seep past the O-rings 214 when the feeder tube sleeve 208 is crimped over the heat exchanger tube 210 and the O-rings 214.

The adhesive 216 is generally applied by injecting the adhesive 216 via a syringe and/or any other method or machine between the feeder tube sleeve 208 and the heat exchanger tube 210 and between the O-rings 214 through at least one hole 220 in the feeder tube sleeve 208. Additionally, at least one additional hole 220 may be disposed in the feeder tube sleeve 208 to release pressure caused by injecting the adhesive 216. In other embodiments, however, the adhesive may be applied prior to assembling the crimp joint 200. After the adhesive 216 has been injected, the adhesive 216 may require a curing time before the crimp joint 200 is completed. Typically, this curing time may be about one or two hours. However, it will be appreciated that the crimp joint 200 may be fully functional even before the adhesive 216 is fully cured, due to the O-rings 214 that provide a workable fluid tight seal. Accordingly, the crimp joint 200 and/or the outdoor heat exchanger 114 may be tested before the adhesive 216 is fully cured.

After the adhesive 216 is applied, the crimp joint 200 may be crimped. To accomplish crimping of the crimp joint 200, the feeder tube sleeve 208 may be compressed over the heat exchanger tube 210 and/or the O-rings 214 to form a crimp 218. The crimp 218 may generally compress the feeder tube sleeve 208 so that the adhesive 216 substantially fills a space between the feeder tube sleeve 208, the heat exchanger tube 210, and the O-rings 214. Thus, the crimp 218 may hold the O-rings 214 stationary within the crimp joint 200 to form a unitary fluid tight seal. In some embodiments, the crimp 218 may be accomplished manually. However, in this embodiment, the crimp 218 is applied by a special crimping tool designed for the elliptical feeder tubes 204 and elliptical heat exchanger tubes 210.

The crimp joint 200 is configured to allow for expansion and/or contraction of the feeder tubes 204 and the heat exchanger tubes 210 caused by fluctuations in temperature that the tubes 204, 210 are exposed to as a result of various environmental factors and/or refrigerant temperature fluctuation that results in operating the outdoor heat exchanger 114 in each of a cooling mode and a heating mode. Accordingly, the crimp joint 200 generally comprises a reliable joint that may resist damage, corrosion, and/or leakage caused by temperature fluctuations and/or other environmental factors the crimp joint 200 is exposed to for at least about ten years. The crimp joint 200 may generally be configured to join similar metals. For example, each of the feeder tube 204 and the heat exchanger tube 210 may comprise a similar metal, such as but not limited to, copper, aluminum, and/or any other metal. However, the crimp joint 200 may also be configured to join dissimilar metals. For example, the feeder tube 204 may comprise aluminum, while the heat exchanger tube 210 comprises copper.

The crimp joint 200 may be employed in a variety of heat exchanger configurations. While the crimp joint 200 is discussed in the application of a spine fin heat exchanger, the crimp joint 200 may be used for any other heat exchanger, and/or any other tube connection. Additionally, while the crimp joint 200 is discussed in the application of elliptical-shaped tubes 204, 210, the crimp joint 200 may also be used for any tube shape and/or configuration, including, but not limited to, round, square, and/or any other shaped tubes. However, it will be appreciated that crimp joint 200 solves a specific problem presented by elliptical spine fin tubes that have ridges and/or adhesive from the manufacturer. Additionally, while in a preferred embodiment, the heat exchanger tube 210 comprises the male connection and the feeder tube 204 comprises the female connection, it will be appreciated that in some embodiments, the feeder tube 204 may be inserted into the heat exchanger tube 210, and the O-rings 214 may be disposed about the feeder tube 204. In other words, the roles of the feeder tube 204 and the heat exchanger tube 210 are reversed.

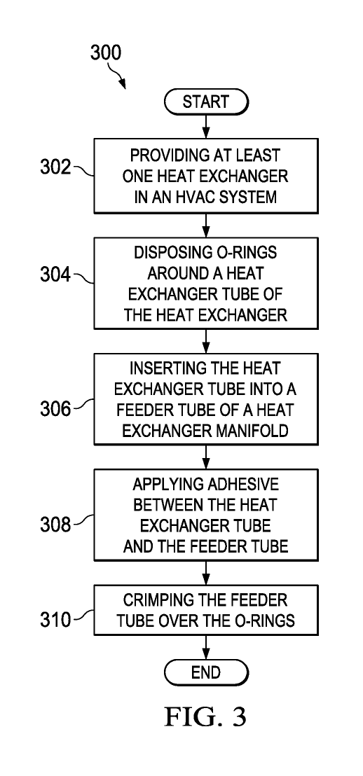

Referring now to FIG. 3, a flowchart of a method 300 of assembling a joint is shown according to an embodiment of the disclosure. In some embodiments, the joint may be crimp joint 200. The method 300 may begin at block 302 by providing at least one heat exchanger in an HVAC system 100. In some embodiments, the heat exchanger may be outdoor heat exchanger 114. However, in other embodiments, the heat exchanger may be any other heat exchanger, such as indoor heat exchanger 108. The method 300 may continue at block 304 by disposing O-rings 214 around a heat exchanger tube 210 of the heat exchanger. In some embodiments, O-rings 214 may be disposed about heat exchanger tube 210. The method 300 may continue at block 306 by inserting the heat exchanger tube 210 into a feeder tube 204 of a heat exchanger manifold 202. In some embodiments, heat exchanger tube 210 may be inserted into feeder tube 204 and/or a feeder tube sleeve 208 of feeder tube 204 of manifold 202. The method 300 may continue at block 308 by applying adhesive 216 between the heat exchanger tube 210 and the feeder tube 204 and/or the feeder tube sleeve 208. The method 300 may conclude at block 310 by crimping the feeder tube 204 and/or the feeder tube sleeve 208 over the O-rings 214. In some embodiments, the feeder tube 204 and/or the feeder tube sleeve 208 may also be crimped over the heat exchanger tube 210. Additionally, it will be appreciated that in some embodiments, the feeder tube 204 may be inserted into the heat exchanger tube 210, and the O-rings 214 may be disposed about the feeder tube 204. Furthermore, in some embodiments, method 300 may be repeated for multiple heat exchanger tubes 210 and multiple feeder tubes 204, and/or a plurality of crimp joints 200 may be assembled simultaneously.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Unless otherwise stated, the term “about” shall mean plus or minus 10 percent of the subsequent value. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention.

What is claimed is:

1. A heat exchanger, comprising:
a manifold;
at least one feeder tube extending from the manifold;
at least one heat exchanger tube; and
a joint that provides a fluid tight seal between the feeder tube and the heat exchanger tube, wherein at least two O-rings are disposed between the feeder tube and the heat exchanger tube, and wherein an adhesive is applied at least in a space between the two O-rings, the feeder tube, and the heat exchanger tube.

2. The heat exchanger of claim 1, wherein the heat exchanger tube is configured to receive at least a portion of the feeder tube.

3. The heat exchanger of claim 1, wherein the feeder tube is configured to receive at least a portion of the heat exchanger tube.

4. The heat exchanger of claim 1, wherein the feeder tube comprises a feeder tube sleeve configured to receive at least a portion of the heat exchanger tube.

5. The heat exchanger of claim 4, wherein the feeder tube sleeve comprises at least one hole between the two O-rings for receiving the adhesive.

6. The heat exchanger of claim 1, wherein the two O-rings provide a fluid tight seal prior to the adhesive curing.

7. The heat exchanger of claim 1, further comprising:
a crimp configured to compress the feeder tube sleeve about the heat exchanger tube and the O-rings.

8. The heat exchanger of claim 1, wherein the feeder tube and the heat exchanger tube comprise an elliptical shape.

9. The heat exchanger of claim 8, wherein the heat exchanger comprises a spine fin heat exchanger.

10. A heating, ventilation, and/or air conditioning (HVAC) system, comprising:
a heat exchanger comprising:
a manifold;
at least one feeder tube extending from the manifold;
at least one heat exchanger tube; and
a joint that provides a fluid tight seal between the feeder tube and the heat exchanger tube, wherein at least two O-rings are disposed between the feeder tube and the heat exchanger tube, and wherein an adhesive is applied at least in a space between the two O-rings, the feeder tube, and the heat exchanger tube.

11. The HVAC system of claim 10, wherein the heat exchanger tube is configured to receive at least a portion of the feeder tube.

12. The HVAC system of claim 10, wherein the feeder tube is configured to receive at least a portion of the heat exchanger tube.

13. The HVAC system of claim 10, wherein the feeder tube comprises a feeder tube sleeve configured to receive at least a portion of the heat exchanger tube.

14. The HVAC system of claim 13, wherein the feeder tube sleeve comprises at least one hole between the two O-rings for receiving the adhesive.

15. The HVAC system of claim 14, further comprising:
a crimp configured to compress the feeder tube sleeve about the heat exchanger tube and the O-rings.

16. The HVAC system of claim 11, wherein the feeder tube and the heat exchanger tube comprise an elliptical shape, and wherein the heat exchanger comprises a spine fin heat exchanger disposed in an outdoor unit of the HVAC system.

17. A method of assembling a joint, comprising:
providing at least one heat exchanger comprising a manifold, at least one feeder tube extending from the manifold, and at least one heat exchanger tube;
disposing O-rings around the heat exchanger tube of the heat exchanger;
inserting the heat exchanger tube into a portion of the feeder tube;
applying adhesive between the heat exchanger tube and the feeder tube; and
crimping the feeder tube over the heat exchanger tube and the O-rings.

18. The method of claim 17, wherein the applying adhesive between the heat exchanger tube and the feeder tube is accomplished by injecting the adhesive through a hole in the portion of the feeder tube that receives the heat exchanger tube, and wherein the hole is disposed between the O-rings.

19. The method of claim 17, wherein the joint comprises a fluid tight seal prior to applying the adhesive between the heat exchanger tube and the feeder tube.

20. The method of claim 17, wherein the feeder tube and the heat exchanger tube comprise an elliptical shape, and wherein the heat exchanger comprises a spine fin heat exchanger.
